(19) United States
(12) Patent Application Publication
(10) Pub. No.: US 2024/0283239 A1
(43) Pub. Date: Aug. 22, 2024

(54) POWER SUPPLY DEVICE AND IMAGE FORMATION APPARATUS

(71) Applicant: Oki Electric Industry Co., Ltd., Tokyo (JP)

(72) Inventor: Ouji MATSUNO, Tokyo (JP)

(73) Assignee: Oki Electric Industry Co., Ltd., Tokyo (JP)

(21) Appl. No.: 18/545,756

(22) Filed: Dec. 19, 2023

(30) Foreign Application Priority Data
Feb. 16, 2023 (JP) 2023-022480

(51) Int. Cl. H02H 7/12; G03G 15/00; H02M 1/42; H02M 3/335

(52) U.S. Cl. CPC H02H 7/1213; G03G 15/80; H02M 1/4208; H02M 3/33523

(57) ABSTRACT

One or more embodiment may be a power supply device that includes: a heater; a voltage converter configured to convert an input voltage to a direct current voltage; a switching part configured to turn on and off an application of the input voltage to the heater in response to an on/off control signal; a detector configured to detect whether the input voltage is a direct current or an alternating current and output a detection signal including the detected information; and a shutoff part configured to receive the detection signal and forcibly turns off the switching part when the input voltage is the direct current.

### CROSS REFERENCE TO RELATED APPLICATIONS

This application claims priority based on 35 USC 119 from prior Japanese Patent Application No.2023-022480 filed on Feb. 16, 2023, entitled “POWER SUPPLY DEVICE AND IMAGE FORMATION APPARATUS,” the entire contents of which are incorporated herein by reference.

### BACKGROUND

The disclosure may relate to a power supply device and an image formation apparatus with a power supply device.

In a related art, in order to prevent a current from continuing to flow to a heater when a direct current (DC) voltage is applied as an input voltage in an image formation apparatus, there is a method of detecting the DC voltage and blowing a fuse to prevent the current from continuing to flow so as to protect the heater circuit (See, Patent Document 1).

Patent Document 1: Japanese Patent Application Publication No. 2020-197559 (see Page 39, FIG. 30)

### SUMMARY

However, the configuration described above uses a detection circuit dedicated to detect the DC voltage, which may cause a problem that increases the number of components and increases the power consumption. In addition, there may be a problem that the device do not operate even when the input voltage returned to an alternating current (AC) voltage due to the protection by the blown fuse.

An aspect of one or more embodiments of the disclosure may be a power supply device that may include: a heater; a voltage converter configured to convert an input voltage to a direct current voltage; a switching part configured to turn on and off an application of the input voltage to the heater in response to an on/off control signal; a detector configured to detect whether the input voltage is a direct current or an alternating current and output a detection signal including the detected information; and a shutoff part configured to receive the detection signal and forcibly turns off the switching part when the input voltage is the direct current.

According to the aspect described above, when the input voltage is turned to the DC voltage, the drive current is prevented from flowing to the heater, and when the input voltage returns to the AC voltage, the drive current can flow to the heater when necessary.

### BRIEF DESCRIPTION OF DRAWINGS

FIG. 1 is a diagram illustrating a view of a part of a configuration of an image formation apparatus according to a first embodiment;

FIG. 2 is a block diagram illustrating a control-related configuration of parts of a power supply part as a power supply device and a controller of the image formation apparatus;

FIG. 3 is a block diagram illustrating a detailed configuration of the power supply part illustrated in FIG. 2;

FIG. 4 is a time chart illustrating changes in operations states detected at parts in the circuit diagram illustrated in FIG. 3 when an input voltage (A) is changed from an alternating current (AC) to a direct current (DC) in an operation process of the power supply part;

FIG. 5 is a time chart illustrating changes in operation states detected at the parts in the circuit diagram illustrated in FIG. 3 when the input voltage (A) is changed from 100V to OFF in an operation process of the power supply part;

FIG. 6 is a block diagram illustrating a control-related configuration of parts of a power supply part and a controller of an image formation apparatus according to a comparative example;

FIG. 7 is a block diagram illustrating a detailed configuration of the power supply part illustrated in FIG. 6;

FIG. 8 is a time chart illustrating changes in operation states detected at parts in the circuit diagram illustrated in FIG. 7 when an input voltage (A) is changed from an alternating current (AC) to a direct current (DC) in an operation process of the power supply part according to the comparative example; and

FIG. 9 is a time chart illustrating changes in operation states detected at parts illustrated in the circuit diagram in FIG. 7 when the input voltage (A) is changed from 100V to OFF in an operation process of the power supply part according to the comparative example.

### DETAILED DESCRIPTION

Descriptions are provided hereinbelow for one or more embodiments based on the drawings. In the respective drawings referenced herein, the same constituents are designated by the same reference numerals and duplicate explanation concerning the same constituents is omitted. All of the drawings are provided to illustrate the respective examples only.

### (First Embodiment)

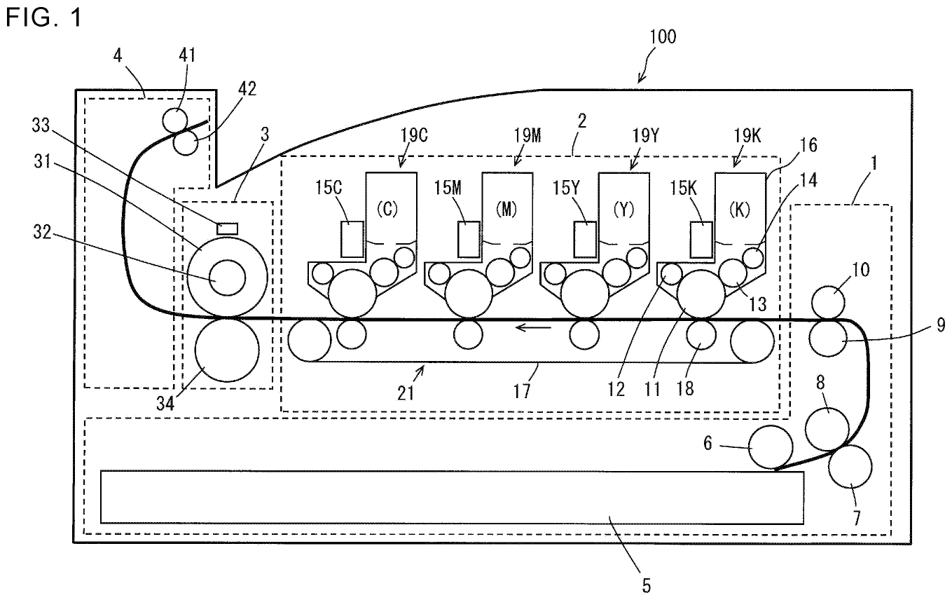

FIG. 1 is a configuration diagram illustrating a configuration of a part of an image formation apparatus 100 according to a first embodiment.

As illustrated in FIG. 1, the image formation apparatus 100 is broadly divided into a paper feeder 1, an image formation section 2, a fixation device 3, and a paper discharging part 4. The paper feeder 1 includes a paper cassette 5 configured to store therein recording paper (recording media), pick-up rollers 6, 7, and 8 configured to take the recording paper out of the paper cassette 5 while separating the recording paper into one by one and feed them into a paper conveyance path (a substantially S-shaped path illustrated by the bold line illustrated in FIG. 1), and resist rollers 9 and 10 configured to convey the recording paper to the image formation section 2.

The image formation section 2 includes four toner image formation units 19K, 19Y, 19M, and 19C (may be simply referred to as toner image formation units 19 when there is no need to distinguish between them) arranged in series in order from the upstream of the paper conveyance direction, LED heads 15K, 15Y, 15M, and 15C (may be simply referred to as LED heads 15 when there is no need to distinguish between them) arranged corresponding to the toner image formation units 19, respectively, and a transfer part 21 (a transfer device) configured to transfer toner images formed by the toner image formation units 19 to the top surface of the paper sheet by Coulomb force.

The toner image formation unit 19K forms a black (K) toner image (developer image), the toner image formation unit 19Y forms a yellow (Y) toner image (developer image), the toner image formation unit 19M forms a magenta (M) toner image (developer image), and the toner image formation unit 19C forms a cyan (C) toner image (developer image). Each of the toner image formation units 19 has a common configuration except for the use of different colored toners.

Each of the toner image formation units 19 includes: a photosensitive drum 11 serving as an electrostatic latent image carrier; a charging roller 12 provided in contact with the photosensitive drum 11 and configured to uniformly charge the surface of the photosensitive drum 11 to a high voltage; a developer roller 13 configured to develop with the toner an electrostatic latent image formed on the surface of the photosensitive drum 11 by means of a LED head 15 provided above the photosensitive drum 11; a toner supply roller 14 provided in contact with the developer roller 13 to supply the toner to the developer roller 13; and a toner cartridge 16 that is removably attached and accommodates therein the toner to supply the toner. Note that each of the LED heads 15 selectively exposes the charged surface of the corresponding photosensitive drum 11 to form the electrostatic latent image.

The transfer part 21 includes a transfer belt 17 configured to carry the recording paper conveyed from the paper feeder 1 in the direction of the arrow illustrated in FIG. 1 and four transfer rollers 18 respectively provided opposite to the photosensitive drums 11 of the toner image formation units 19 with the transfer belt 17 therebetween. The transfer part 21 transfers, by Coulomb force, the toner images (developer images) of the respective colors sequentially onto the recording paper such that the toner images of the respective colors are superimposed with each other on the recording paper.

The fixation device 3 includes a fixation roller 31, a halogen lamp 32 serving as a heater provided inside the fixation roller 31, a temperature detection sensor 33, such as a thermistor or the like, configured to detect the surface temperature of the fixation roller 31, and a pressure roller 34 provided in pressure contact with the fixation roller 31 to apply heat and pressure to the toner image transferred to the recording paper so as to fix the toner image on the recording paper. In the paper discharging part 4, discharge rollers 41 and 42 are arranged to discharge the recording paper on which the fixation is completed.

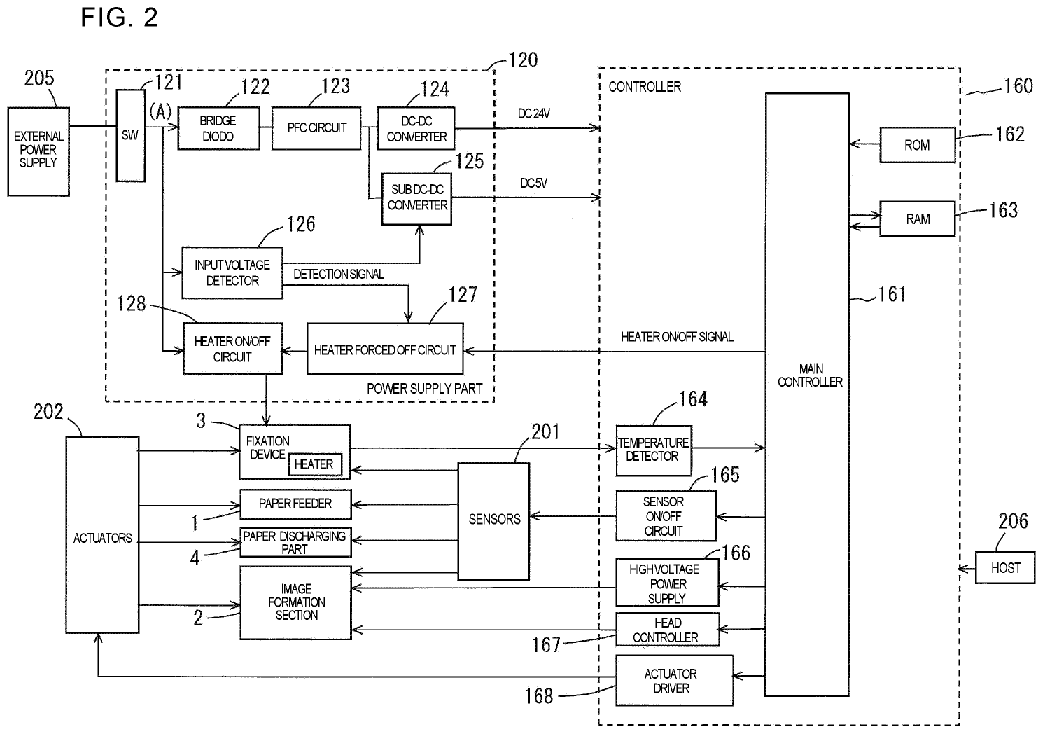

Next, a control system of the image formation apparatus 100 equipped with a power supply part 120 according to an embodiment is described. FIG. 2 is a block diagram illustrating a control-related configuration of the power supply part 120 serving as a power supply device and a controller 160 of the image formation apparatus 100.

In FIG. 2, the power supply part 120 is roughly divided into a switch 121, a bridge diode 122, a PFC circuit 123, a DC-DC converter 124, a sub DC-DC converter 125, an input voltage detector 126 serving as a detector, a heater forced off circuit 127 serving as a shutoff part, and a heater on/off circuit 128 serving as a switching part, and is operated by an alternating current (AC) voltage outputted from an external power supply 205. The switch 121 is a manual switch provided at an input part of the power supply part 120 and configured to turn on and off the input of the external power supply 205, but may be a switch configured to be turned on and off by a device controller or the like. Note that the bridge diode 122, the PFC circuit 123, the DC-DC converter 124, and the sub DC-DC converter 125 correspond to a voltage converter.

Here, it is assumed that the input voltage from the external power supply 205 is an AC voltage into which a direct current (DC) voltage is converted through an inverter, as in, for example, a solar power generation system. Therefore, as described below, it is assumed that there may be cases where the DC voltage is input from the external power supply 205 without being converted to the AC voltage due to a fault in the inverter.

The heater on/off circuit 128 is configured to turn on and off the heater inside the fixation device 3 in response to a control signal generated by the heater forced off circuit 127 based on a heater on/off signal output from a main controller 161, as described below.

The PFC circuit 123 constitutes an AC-DC converter that boosts the alternating current (AC) voltage to the direct current (DC) voltage, and is a so-called PFC (Power Factor Correction) circuit for improving the power factor. The PFC circuit 123 receives a full-wave rectification voltage, which is an output of the bridge diode 122, and outputs the boosted DC voltage to the DC-DC converter 124 and the sub DC-DC converter 125.

The DC-DC converter 124 supplies a DC voltage to the controller 160. In this example, the DC-DC converter 124 supplies the DC voltage of 24V (DC 24V) to an actuator system. The sub DC-DC converter 125 supplies a DC voltage of 5V (DC 5V) to a logic system of the controller 160, but outputs, based on a detection signal received from the input voltage detector 126, the voltage of 0V when the AC input is turned off, as described below. The DC voltages outputted from the power supply part 120 are generally determined by the configuration of the controller 160. For example, DC 3.3V may be outputted in addition.

The input voltage detector 126 detects the input voltage as described below and outputs the detection signal indicating a status of the input voltage to the sub DC-DC converter 125 and the heater forced off circuit 127. Based on the detection signal, the heater forced off circuit 127 forces the heater on/off signal that enters to the heater on/off circuit 128 to a low state (“L”) when the input voltage becomes the direct current.

The controller 160 includes a main controller 161, a read-only memory (ROM) 162, a random access memory (RAM) 163, a temperature detector 164, a sensor on/off circuit 165, a high voltage power supply 166, a head controller 167, and an actuator driver 168.

The main controller 161 is a device that operates by a program written in the ROM 162, which is a nonvolatile memory component storing programs and setting data. The RAM 163 is a memory for data storage and readout.

The temperature detector 164 divides the output of the temperature detection sensor 33 (FIG. 1) in the fixation device 3 by resistance and outputs a temperature detection signal to the main controller 161. Based on the temperature detection signal, the main controller 161 performs a temperature control by outputting the heater on/off signal so that the temperature inside the fixation device 3 becomes a desired temperature.

The sensor on/off circuit 165 is configured of a transistor(s), and basically receives a sensor off signal from the main controller 161 and switches off the supply of power to various sensors 201 described below, unless in an apparatus warm-up operation when the apparatus is powered on or in printing operation according to a command from the host 206 or the like. The high voltage power supply 166 applies a high voltage to the photosensitive drum 11 and the rollers of the image formation section 2 explained with reference to FIG. 1.

The head controller 167 is a controller that controls on/off of the LED head 15 illustrated in FIG. 1. The actuator driver 168 is a dedicated driver that outputs drive signals to actuators 202 described below based on a logic signal output from the main controller 161. The paper feeder 1, the image formation section 2, and the paper discharging part 4 are as described in FIG. 1 above.

The sensors 201 may include a paper travel path sensor(s) for detecting a paper location, a sensor(s) for correcting image density, and a sensor(s) for correcting color deviation, which may be provided in the paper feeder 1, the image formation section 2, the fixation device 3, and the paper discharging part 4. The actuators 202 includes a motor(s), a clutch(s), a solenoid(s), and a cooling fan(s) which may be provided in the paper feeder 1, the image formation section 2, the fixation device 3, and the paper discharging part 4. The actuators 202 are driven by the actuator driver 168.

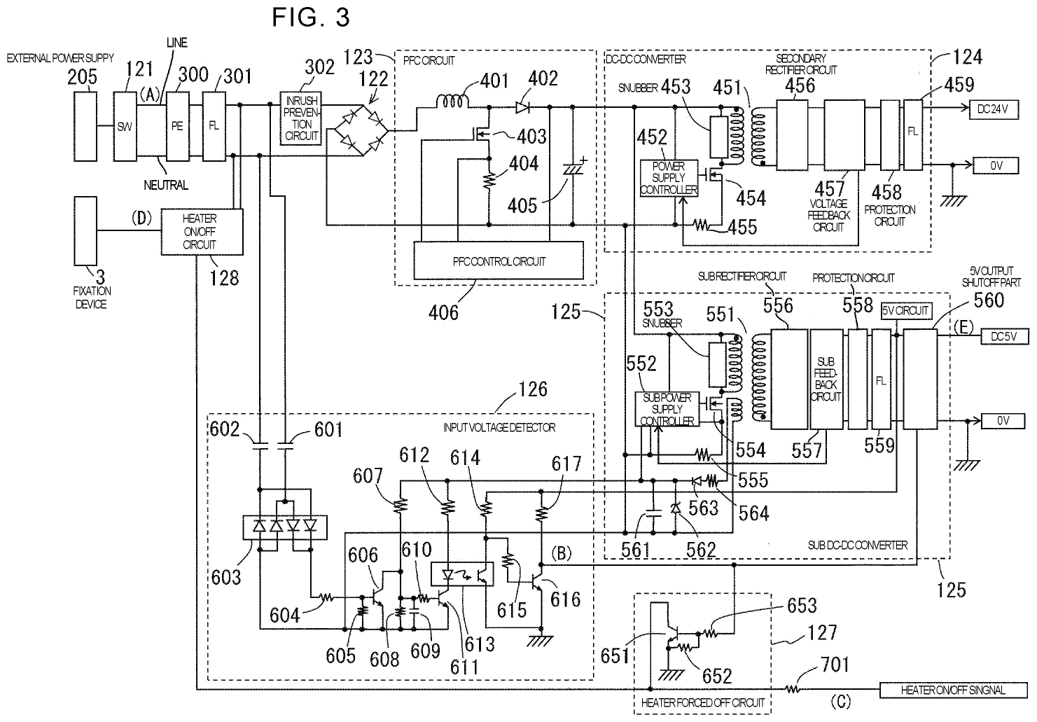

FIG. 3 illustrates a block diagram of a detailed configuration of the power supply part 120 explained with reference to FIG. 2, and is roughly divided into the switch 121, a protection element 300, a filter 301, an inrush current prevention circuit 302, the bridge diode 122, the PFC circuit 123, the DC-DC converter 124, the sub DC-DC converter 125, the input voltage detector 126, the heater forced off circuit 127, and the heater on/off circuit 128.

The protection element 300 may be configured of a fuse for protection from overcurrent, a varistor for protection from lightning surge, or the like. The filter 301 is typically configured of a common or normal choke coil and capacitor. The capacitor is configured of an X-conductor provided between LINE and NEUTRAL and a Y-conductor provided between LINE or NEUTRAL and FG (frame ground).

The inrush current prevention circuit 302 is a circuit that suppresses an inrush current of a PFC output electrolytic capacitor 405. An inexpensive configuration of the inrush current prevention circuit 302 may be a thermistor but can not prevent the inrush current when the thermistor is hot. Accordingly, a circuit combining a resistor and a switch element such as a triac and a relay may be used as the inrush current prevention circuit 302. The bridge diode 77 is configured of four diodes. As the bridge diode 77, an element called a four-element bridge diode may be generally used.

The PFC circuit 123 includes a PFC power device 403 serving as a switching device, e.g., a FET, a PFC coil 401, a current detection resistor 404, a PFC diode 402, the PFC output electrolytic capacitor 405, and a PFC control circuit 406. The

PFC control circuit 406 is a controller of the PFC circuit 123 that receives the alternating current voltage rectified by the bridge diode 122, converts the alternating current voltage to a direct current voltage with being boosted. The PFC control circuit 406 may be generally configured of a dedicated IC, a microcontroller, or the like.

Considering the maximum AC input, the voltage to be boosted is generally set to about 383 [V] (=AC 264 [V]×√2+10 [V]) for the worldwide input. A one-phase configuration is used in an embodiment, but more than one-phase configuration, such as two-phase, three-phase, or the like, is also acceptable.

The PFC control circuit 406 receives the detection result of the output voltage and the detection result of the current detection resistor 404, determines a gate voltage of the PFC power device 403, and outputs the determined gate voltage. The PFC coil 401 is a boost coil. The PFC power device 403 which is the FET is a power device for switching, and a gate input terminal thereof is input from the PFC control circuit 406. The current detection resistor 404 is a resistor that detects a drain current of the PFC power device 403, and the detection result thereof is outputted to the PFC control circuit 406. The PFC diode 402 is a rectifier diode that outputs to the PFC output electrolytic capacitor 405. The PFC output electrolytic capacitor 405 smoothes the PFC output voltage and delays an output voltage drop in the event of a power supply momentary breakdown.

The DC-DC converter 124 is configured of a transformer 451, a main FET 454, a snubber circuit 453, a power supply controller 452, a current detection resistor 455, a secondary rectifier circuit 456, a voltage feedback part 457, a protection circuit 458, and a filter 459.

The transformer 451 includes a primary side and a secondary side thereof isolated to each othter and functions to transform the PFC output voltage outputted by the PFC circuit 123. The main FET 454 turns on and off the power supplied to the primary winding of the transformer 451. The snubber circuit 453 is a circuit that suppresses a surge voltage when the main FET 454 is off. The snubber circuit 453 often is configured of a diode(s), a resistor(s), and a capacitor(s). The power supply controller 452 determines an on-duty of a gate voltage of the main FET 454 mainly based on the result of feedback of the DC output voltage on the secondary side.

The secondary rectifier circuit 456 rectifies and smoothes the output voltage of the secondary winding of the transformer 451. Here, the DC voltage of 24V is used as the winding single output, and a rectifier diode and electrolytic capacitor are placed. The voltage feedback part 457 divides the output voltage and outputs the detection result based on the divided voltage to the power supply controller 452.

The protection circuit 458 includes an overvoltage detection circuit or an overcurrent detection circuit. The overvoltage protection circuit is configured of a Zener diode and a photocoupler. When detecting an overvoltage, the overvoltage detection circuit stops the output by latching or intermittently stopping, by the power supply controller 452 on the primary side. The overcurrent detection circuit may have various circuit configurations such as current detection, DC output voltage droop detection, a fuse, or the like. The power supply controller 452 may be used to detect an overcurrent as a primary current. The secondary filter 459 is an LC filter. The secondary filter 459 is not necessarily required to be mounted, but used as ripple voltage or ripple noise voltage suppression.

The sub DC-DC converter 125 is configured of a transformer 551, an FET 554, a snubber circuit 553, a sub power supply controller 552, a current detection resistor 555, a sub rectifier circuit 556, a sub feedback part 557, a protection circuit 558, a filter 559, a 5V output shutoff part 560, a current detection resistor 564, a rectifier diode 563, a Zener diode 562, and a capacitor 561.

The transformer 551 includes a primary side and a secondary side thereof isolated to each other and functions to transform the PFC output voltage outputted by the PFC circuit 123. The main FET 554 turns on and off the power supplied to the primary winding of the transformer 551. The snubber circuit 553 is a circuit that suppresses a surge voltage when the main FET 554 is off. The snubber circuit 453 is often configured of a diode(s), a resistor(s), and a capacitor(s). The sub power supply controller 552 determines an on-duty of a gate voltage of the main FET 554 mainly based on the result of feedback of the DC output voltage on the secondary side.

The sub rectifier circuit 556 rectifies and smoothes the output voltage of the secondary winding of the transformer 551. Here, the DC voltage of 5V is used as the winding single output, and a rectifier diode and an electrolytic capacitor are placed. The sub feedback part 557 divides the output voltage and outputs the detection result based on the divided voltage to the sub power supply controller 552.

The protection circuit 558 includes an overvoltage detection circuit or an overcurrent detection circuit. The overvoltage protection circuit is configured of a

Zener diode and a photocoupler. When detecting an overvoltage, the overvoltage detection circuit stops the output by latching or intermittently stopping, by the power supply controller 552 on the primary side. The overcurrent detection circuit may have various circuit configurations such as current detection, DC output voltage droop detection, a fuse, or the like. The sub power supply controller 552 may be used to detect an overcurrent as a primary current. The secondary filter 559 is an LC filter.

The secondary filter 559 is not necessarily required to be mounted, but used as ripple voltage or ripple noise voltage suppression.

The 5V output shutoff part 560 serving as an output shutoff part receives the input voltage detection signal serving as a control signal from the input voltage detector 126 and stops the output thereof according to the status of the input voltage as described below. The current detection resistor 564 and the rectifier diode 563 that are connected to one end of an auxiliary winding of the transformer 551 are a current detection resistor and a rectifier diode of the auxiliary winding of the transformer 551, respectively. The Zener diode 562 limits the voltage to prevent overvoltage to the sub-power supply controller 552 and the capacitor 561 when the auxiliary winding voltage becomes high.

In the input voltage detector 126, one pair of an anode-side input and a cathode-side input of the bridge diode 603 are connected to the LINE side and the NEUTRAL side of the external power supply 205 via a capacitor 601, and the other pair of an anode-side input and a cathode-side input of the bridge diode 603 are connected to the LINE side and the NEUTRAL side via a capacitor 602. An anode-side output of the bridge diode 603 is directly connected to emitters of transistors 606 and 611 and the other end of the auxiliary winding of the transformer 551, while a cathode-side output of the bridge diode 603 is connected to a base of the transistor 606 via a resistor 604.

The base of the transistor 606 is connected to an emitter of the transistor 606 via a resistor 605. A collector of the transistor 606 is connected to the emitter of the transistor 606 via a resistor 608, is connected to the emitter of the transistor 606 via a capacitor 609, is connected to a cathode of the rectifier diode 563 via a resistor 607, and is connected to the base of the transistor 611 via a resistor 610. An anode terminal of a photocoupler 613 is connected to the cathode of the rectifier diode 563 via a resistor 612, a cathode terminal of the photocoupler 613 is connected to the collector of the transistor 611, a collector terminal of the photocoupler 613 is connected to a 5V circuit of the filter 559 via a resistor 614 and connected to a base of the transistor 616 via a resistor 615, and an emitter terminal of the photocoupler 613 is grounded. A collector of the transistor 616 is connected to the 5V circuit of the filter 559 via a resistor 617 and connected to the 5V output shutoff part 560.

In the configuration described above, in the input voltage detector 126, when the input voltage changes from the alternating current to the direct current or turns off, the transistor 606 turns off, which causes, after a predetermined time, the transistor 611 to turn on and the photocoupler 613 to turn on, so that the input voltage detection signal, indicating the state of the collector of the transistor 616, reverses from the low level (“L”) to the high level (“H”). At this timing, the 5V output shutoff part 560 shuts off the output thereof.

Note that since the output load current of the DC voltage of 5V outputted by the 5V output shutoff part 560 is small (e.g., 0.3 W at a power save mode), the charge on the capacitor in the sub rectifier circuit 556 is not immediately discharged when the input voltage is turned off. Therefore, to prevent inconveniences, such as not being able to confirm a reset, for example, due to the fact that the voltage of 5V charged to the sub rectifier circuit 556 does not drop, the 5V output shutoff part 560 shuts off the output thereof at least when the input voltage is off.

In the heater forced off circuit 127, a base of a transistor 651 is connected to the collector of the transistor 616 of the input voltage detector 126 via a resistor 653 and grounded via a resistor 652, a collector of the transistor 651 is connected via a resistor 701 to the control signal input part of the heater on/off circuit 128 which receives the the heater on/off signal, and an emitter of the transistor 651 is directly grounded.

With the configuration described above, when the input voltage detection signal becomes the high level (“H”), the transistor 651 turns on, forcing the heater on/off signal inputted to the control signal input part of the heater on/off circuit 128 to the low level (“L”). The heater on/off circuit 128 turns on to supply the input voltage to the heater inside the fixation device 3, when the control signal input part is the high level (“H”), and the heater on/off circuit 128 turns off to stop the supply, when the control signal input part is the low level (“L”). Note that the input voltage detector 126 and the heater forced off circuit 127 may be also constructed by using software. In an embodiment, the configuration of the input voltage detector 126 and the heater forced off circuit 127 is constructed by only hardware.

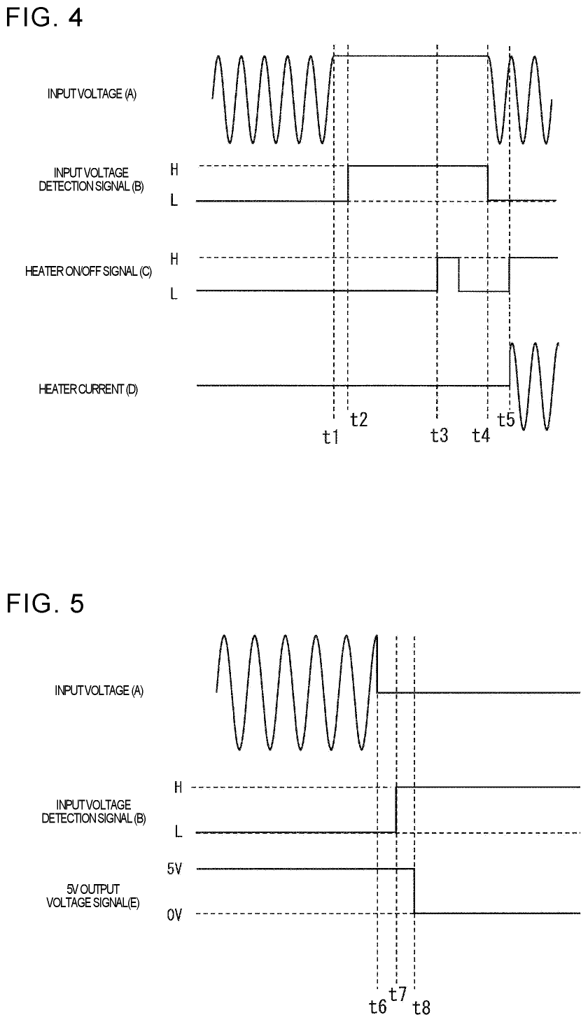

FIG. 4 is a time chart illustrating changes in operation states detected at parts illustrated in the circuit diagram in FIG. 3 when the input voltage (A) is changed from the alternating current to the direct current in an operation process of the power supply part 120 according to an embodiment. The operation of the power supply device is explained below with reference to FIG. 3 and the time chart of FIG. 4. Note that “H” and “L” in the time chart are the higher value (the high level) and the lower value (the low level) in the voltage that changes in a binary manner.

The waveforms illustrated in the time chart of FIG. 4 are as follows. Input voltage (A): an AC voltage outputted from the external power supply 205. Here, the input voltage (A) is the voltage at the rear of the switch 121. The description here is made assuming that the AC voltage is AC 100V. Input voltage detection signal (B):

an output voltage of the input voltage detector 126, which detects the states of the input voltage, i.e., an off state and a direct current state. Heater on/off signal (C): a heater on/off signal outputted from the controller 160 (FIG. 2). Heater current (D): a current flowing to the heater (halogen lamp 32) of the fixation device 3 through the heater on/off circuit 128. Note that the detection points of the waveforms (A) to (D) in the time chart are designated as (A) to (D), respectively, in FIG. 3.

The horizontal axis in the time chart of FIG. 4 is the time axis common to the signals (the waveforms). The operation of the power supply part 120 as the time passes (time t1 to time t5) is described below.

While the input voltage (A) is the alternating current voltage of 100V, the input voltage detection signal (B) of the input voltage detector 126 is the low level (“L”) because the transistor 606 is repeatedly turned on and off and thus the transistor 611 and photocoupler 613 are turned off and the transistor 616 is turned on. Accordingly, the heater on/off signal (C) goes directly to the heater on/off circuit 128 because transistor 651 of the heater forced off circuit 127 is turned off. At this time, the heater current (D) is not flowing because the heater on/off signal (C) is the low level (“L”).

When the input voltage (A) changes from the alternating current to the direct current at time t2, the transistor 606 of the input voltage detector 126 turns off, so that the transistor 611 and the photocoupler 613 turn on and the transistor 616 turns off. Thus, the input voltage detection signal (B) goes to the high level (“H”) at time t2. Accordingly, the transistor 651 of the heater forced off circuit 127 is turned on, so that the heater on/off signal (C) inputted to the heater on/off circuit 128 is forced to stay the low level (“L”).

Therefore, even if the heater on/off signal (C) changes to the high level (“H”) at time t3 in this state, the heater current (D) does not flow because the heater on/off circuit 128 remains off.

Then, when the input voltage (A) returns to the alternating current at time t4, the input voltage detection signal (B) becomes the low level (“L”) and the transistor 651 of the heater forced off circuit 127 is turned off, so that the heater on/off signal (C) enters the heater on/off circuit 128 directly. Therefore, from this state, when the heater on/off signal (C) goes the high level (“H”) at time t5, the heater on/off circuit 128 turns on and the heater current (D) begins to flow.

As described above, while the input voltage (A) is in the direct current state, the input voltage detector 126, the heater forced off circuit 127, and the heater on/off circuit 128 operate to protect the heater by preventing the heater current from flowing even if the heater on/off signal (C) goes the high level (“H”).

FIG. 5 is a time chart illustrating changes in operation states detected at parts illustrated in the circuit diagram in FIG. 3 when the input voltage (A) is changed from the alternating current voltage of 100V to OFF in an operation process of the power supply part 120 according to an embodiment. The operation of the power supply part 120 is explained below with reference to FIG. 3 and the time chart of FIG. 5. Note that the detection points of the waveforms (A), (B), and (E) in the time chart of FIG. 5 are designated as (A), (B), and (E), respectively, in FIG. 3. The 5V output voltage signal (E) indicates the output voltage of the 5V output shutoff part 560.

The horizontal axis of the time chart in FIG. 5 is the time axis common to the signals (the waveforms) in the time chart. The operation of the power supply part 120 as the time passes (time t6 to time t8) is described below.

While the input voltage (A) is the alternating current voltage of 100V, the input voltage detection signal (B) of the input voltage detector 126 is the low level (“L”) because the transistor 606 is repeatedly turned on and off and thus the transistor 611 and the photocoupler 613 are turned off and the transistor 616 is turned on.

Therefore, the 5V output shutoff part 560, which inputs the input voltage detection signal (B) as a control signal, is in the state of outputting the voltage of 5V. Note that the 5V output shutoff part 560 outputs the voltage of 5V as it is when the input voltage detection signal (B) is the high level (“H”), and sets the output to the voltage of 0V when the input voltage detection signal (B) is the low level (“L”).

Then, when the input voltage (A) turns off at time t6, the transistor 606 of the input voltage detector 126 turns off, causing the transistor 611 and the photocoupler 613 to turn on and the transistor 616 to turn off, so that the input voltage detection signal (B) goes the high level (“H”) at time t7. In synchronization with this, the 5V output shutoff part 560 shuts off the output voltage of 5V at time t8 so as to make the output voltage to 0V.

As described above, when the input voltage (A) is turned off, the input voltage detector 126 and the 5V output shutoff part 560 shut off the output voltage of 5V outputted from the 5V output shutoff part 560.

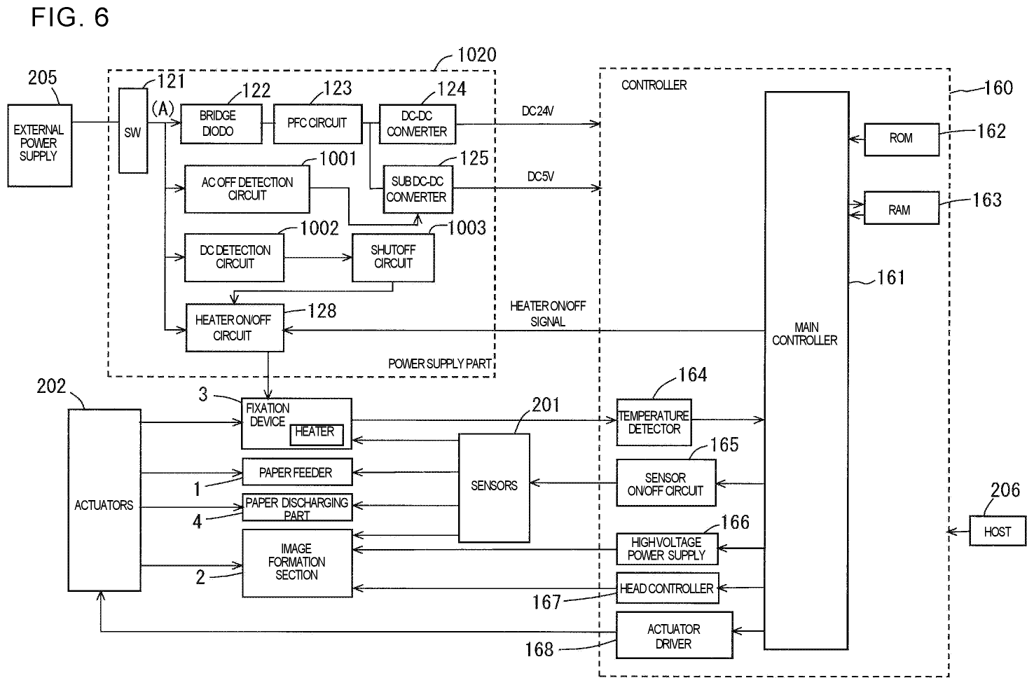

Next, a control system of an image formation apparatus 100 equipped with a power supply part 1020 according to a comparative example is described. FIG. 6 is a block diagram illustrating a control-related configuration of parts of the power supply part 1020 and a controller 160 of the image formation apparatus according to the comparative example.

The power supply part 1020 according to the comparative example differs from the power supply part 120 according to an embodiment illustrated in FIG. 2 in that the power supply part 1020 does not include the input voltage detector 126 and the heater forced off circuit 127, but includes an AC off detection circuit 1001, a DC detection circuit 1002, and a cutoff circuit 1003. Other circuitry in the power supply part 1020 and components other than the power supply part 1020 such as the controller 160 or the like are the same as the components of an embodiment illustrated in FIG. 2. Accordingly, the following descriptions on the comparative example are made mainly for parts different from an embodiment described above, explanations of common parts are omitted, and additional explanations may be added as necessary. Note that the same components are given the same reference numerals.

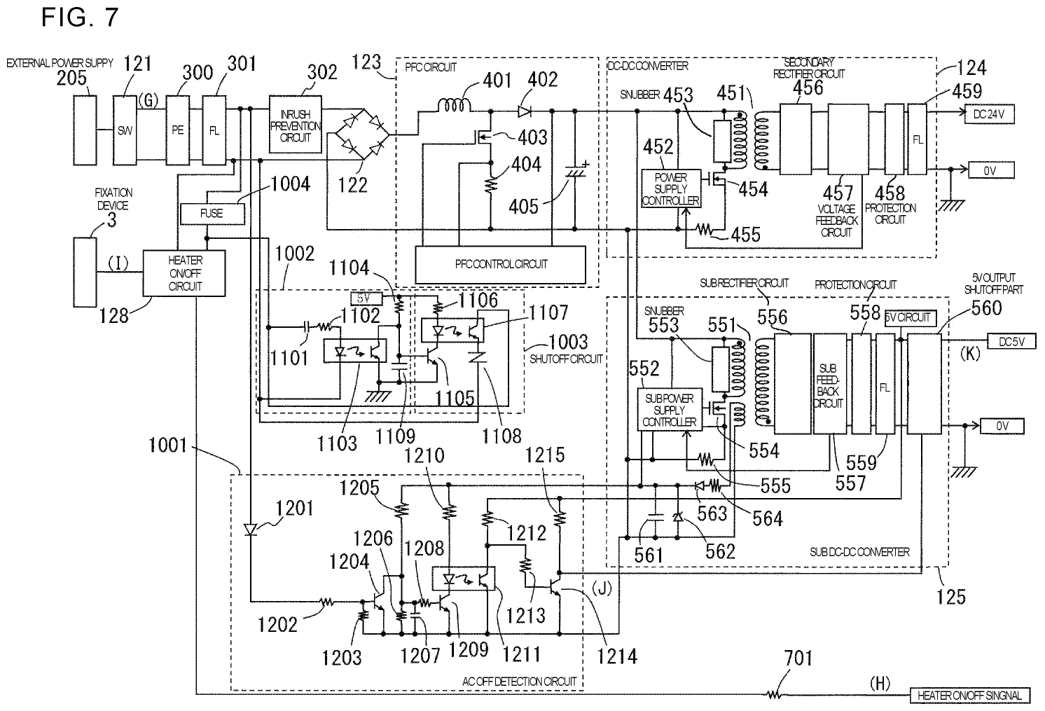

FIG. 7 is a block diagram illustrating a detailed configuration of the power supply part 1020 explained in FIG. 6.

In the AC off detection circuit 1001, a base of a transistor 1204 is connected to the LINE side of the external power supply 205 via a resistor 1202 and a diode 1201 and connected to an emitter of the transistor 204 via a resistor 1203. Emitters of transistors 1204, 1209 and 1214 are connected to the other end of the auxiliary winding of the transformer 551. A collector of the transistor 1204 is connected to the emitter of the transistor 1204 via a resistor 1206, connected to the emitter of the transistor 1204 via a capacitor 1207, connected to a cathode of the rectifier diode 563 via a resistor 1205, and connected to a base of the transistor 1209 via a resistor 1208.

An anode terminal of a photocoupler 1211 is connected to the cathode of the rectifier diode 563 via a resistor 1210, a cathode terminal of the photocoupler 1211 is connected to the collector of the transistor 1209. A collector terminal of the photocoupler 1211 is connected to the 5V circuit of the filter 559 via a resistor 1212 and connected to a base of the transistor 1214 via a resistor 1213. An emitter terminal of the photocoupler 1211 is connected to the emitter of the transistor 1209.

A collector of the transistor 1214 is connected to the 5V circuit of the filter 559 via a resistor 1215 and connected to the 5V output shutoff part 560.

In the configuration described above, when the input voltage turns off, the transistor 1204 turns off, which causes, after a predetermined time, the transistor 1209 to turn on, the photocoupler 1211 to turn on, and the transistor 1214 to turn off, which causes the collector of the transistor 1214 reverses from the low level (“L”) to the high level (“H”), so as to cause, at this timing, the 5V output shutoff part 560 to shut off the output thereof.

In the DC detection circuit 1002, an anode terminal of a photocoupler 1103 is connected via a resistor 1102, a capacitor 1101, and a fuse 1004 to the LINE side of the external power supply 205, and a cathode terminal of the photocoupler 1103 is connected to the NEUTRAL side of the external power supply 205. A collector terminal of the photocoupler 1103 is connected to a 5V power supply via a resistor 1104, and is grounded via a capacitor 1109 and connected to a base of a transistor 1105 of the cutoff circuit 1003. An emitter terminal of the photocoupler 1103 is grounded. In this case, the LINE side of the external power supply 205 is applied to the heater on/off circuit 128 via the fuse 1004.

In the cutoff circuit 1003, a collector of the transistor 1105 is connected to a cathode terminal of a photocoupler 1107 and an emitter of the transistor 1105 is grounded. An anode terminal of the photocoupler 1107 is connected to the 5V power supply via a resistor 1106, a collector terminal of the photocoupler 1107 is connected to the LINE side of the external power supply 205 via the fuse 1004, and an emitter terminal of the photocoupler 1107 is connected to the NEUTRAL side of the external power supply 205 via a varistor 1108.

In the configuration described above, when the input voltage changes from the alternating current to the direct current, the input voltage is cut off by the capacitor 1101, the photocoupler 1103 turns off, the transistor 1105 turns on, and the photocoupler 1107 turns on. This causes the LINE side and the NEUTRAL side of the external power supply 205 to be shorted through the varistor 1108 and the fuse 1004. Note that the varistor 1108 is inserted to prevent sudden voltage and current changes when the photocoupler 1107 is turned on.

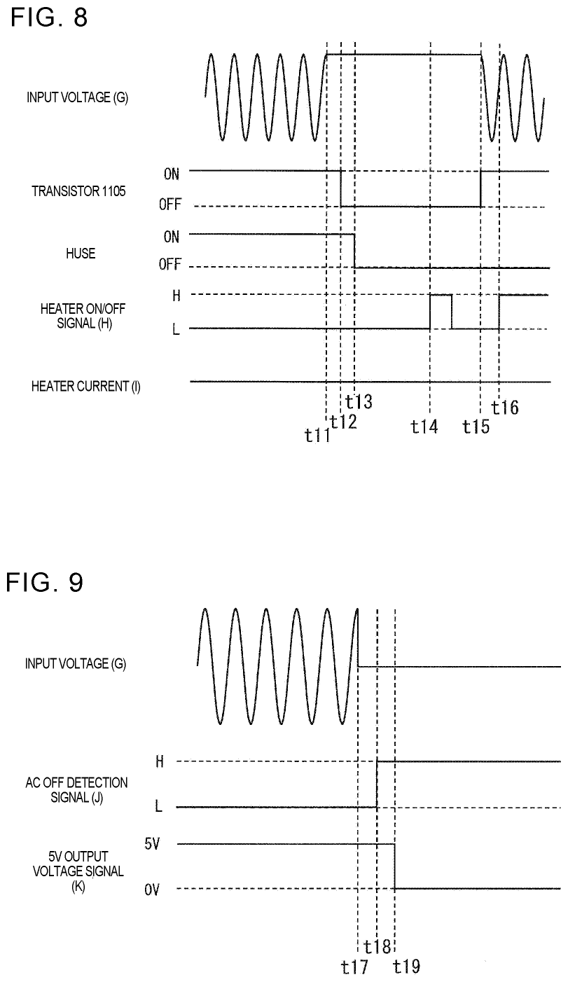

FIG. 8 is a time chart illustrating changes in operation states detected at parts in the circuit diagram illustrated in FIG. 7 when the input voltage (A) is changed from the alternating current to the direct current in an operation process of the power supply part 1020 according to the comparative example. The operation of the power supply part 1020 in the time chart of FIG. 8 is explained below with reference to FIG. 7. Note that the detection points of the waveforms (G) to (I) in the time chart of FIG. 8 are designated as (G) to (I), respectively, in FIG. 7.

The horizontal axis in the time chart of FIG. 8 is the time axis common to the signals (the waveforms) in the time chart. The operation of the power supply part 1020 as the time passes (time t11 to time t16) is described below.

While the input voltage (G) is the alternating current of 100V, the photocoupler 1103 of the DC detection circuit 1002 is repeatedly turned on and off, so that the transistor 1105 and the photocoupler 1107 of the cutoff circuit 1003 are off.

Accordingly, the heater current (I) is not flowing because the heater on/off signal (H) is the low level (“L”) even if the fuse 1004 is normal (ON).

When the input voltage (G) changes from the alternating current to the direct current at time t11, the photocoupler 1103 of the DC detection circuit 1002 turns off, and thus the current flows through the transistor 1105 of the cutoff circuit 1003, turning on the transistor 1105 and the photocoupler 1107, causing a short circuit between the LINE side and the NEUTRAL side of the external power supply 205 through the varistor 1108 and the fuse 1004, causing the fuse 1004 to be blown (turned off).

Accordingly, the alternating current of 100V does not flow to the heater on/off circuit 128, and even when the heater on/off signal goes to the high level (“H”) at time t14, or even when the alternating current of 100V is restored at time t15 and the heater on/off signal goes to the high level (“H”) again at time t16, the heater current (I) remains non-flowing so as to protect the heater.

As described above, when the input voltage (A) reaches the direct current (DC) state, the fuse 1004 is blown, and thereafter no heater current (I) flows to the fixation device 3 until the fuse 1004 is replaced.

FIG. 9 is a time chart illustrating changes in operation states detected at parts illustrated in the circuit diagram in FIG. 7 when the input voltage (A) is changed from the alternating current of 100V to OFF in an operation process of the power supply part 1020 according to the comparative example. The operation of the power supply part 1020 in the time chart of FIG. 9 is explained below with reference to FIG. 7. Note that the detection points of the waveforms (G), (J), and (K) in the time chart of FIG. 9 are designated as (G), (J), and (K), respectively, in FIG. 7.

The horizontal axis in the time chart of FIG. 9 is the time axis common to the signals (the waveforms) in the time chart. The operation of the power supply part 120 as the time passes (time t17 to time t19) is described below.

While the input voltage (G) is the alternating current of 100V, the input voltage detection signal (J) of the AC off detection circuit 1001 is the low level (“L”) because the transistor 1204 is repeatedly turned on and off and thus the transistor 1209 and the photocoupler 1211 are turned off and the transistor 1214 is turned on. Accordingly, the 5V output shutoff part 560 that inputs this input voltage detection signal (J) as the control signal is in the state of outputting the voltage of 5V.

Then, when the input voltage (A) is turned off at time t17, the transistor 1204 of the AC off detection circuit 1001 turns off, causing the transistor 1209 and the photocoupler 1211 to turn on and the transistor 1214 to turn off, so that the input voltage detection signal (J) goes to the high level (“H”) at time t18. In synchronization with this, the 5V output shutoff part 560 shuts off the output voltage of 5V at time t19 so as to make the output voltage to 0V.

As described above, when the input voltage (A) is turned off, the AC off detection circuit 1001 and the 5V output shutoff part 560 shut down the output voltage of 5V from the 5V output shutoff part 560.

As described above, according to the power supply device of an embodiment, while the input voltage (A) is in the direct current (DC) state, no drive current flows to the heater current even if the heater on/off signal (C) goes to the high level (“H”) so as to protect the heater, whereas when the input voltage (A) returns to the alternating current (AC) state, the current control is enabled by the heater on/off signal (C). Further, the same circuit can detect the input off required for the 5V output shutoff when the input is off, which is expected to reduce the circuit area and the power consumption.

In one or more embodiments described above, the case has been described in which the image formation apparatus is the color printer. However, the disclosure may be applied to any other image formation apparatuses such as a mono-color printer, a copier, a fax machine, a multifunctional peripheral (MFP) that combine these devices, and the like. Furthermore, the disclosure can be applied as a power supply for a device that uses a heater.

The invention includes other embodiments or modifications in addition to one or more embodiments and modifications described above without departing from the spirit of the invention. The one or more embodiments and modifications described above are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. A power supply device comprising:
a heater;
a voltage converter configured to convert an input voltage to a direct current voltage;
a switching part configured to turn on and off an application of the input voltage to the heater in response to an on/off control signal;
a detector configured to detect whether the input voltage is a direct current or an alternating current and output a detection signal including the detected information; and
a shutoff part configured to receive the detection signal and forcibly turns off the switching part when the input voltage is the direct current.

2. The power supply device according to claim 1, wherein
the switching part is configured to turn on when receiving the on/off control signal being in a first state and turns off when receiving the on/off control signal being in a second state, and
the shutoff part is configured to force the on/off control signal inputted to the switching part to the second state when the input voltage is the direct current.

3. The power supply device according to claim 2, wherein
the detector is configured to detect that the input voltage is turned off and output the detection signal including the detected information, and
the voltage converter includes an output shutoff part configured, based on the detection signal, to shut off an output of a predetermined voltage, wherein the output shutoff part is configured to shut off the output of the predetermined voltage when the input voltage is turned off.

4. The power supply device according to claim 3, wherein
the shutoff part is configured to release the switching part from being forced off when the input voltage is restored to the alternating current.

5. The power supply device according to claim 4, wherein
the detector is configured of hardware.

6. An image formation apparatus comprising:
the power supply device according to claim 1; and
a controller configured to output the on/off control signal, wherein
the heater is configured as a heat source to heat a recording medium to which a developer image has been transferred.
